(19) United States
(12) Patent Application Publication
(10) Pub. No.: US 2017/0160561 A1
(43) Pub. Date: Jun. 8, 2017

(54) RIMLESS EYEGLASSES

(71) Applicant: Oceanus Investment Inc., Mahe (SC)

(72) Inventor: Zhao-Yun HE, Shenzhen (CN)

(21) Appl. No.: 15/438,119

(22) Filed: Feb. 21, 2017

Related U.S. Application Data
(63) Continuation-in-part of application No. 14/698,250, filed on Apr. 28, 2015.

(30) Foreign Application Priority Data
Apr. 30, 2014 (CN) 201420221855.2
Jul. 25, 2014 (CN) 201420416076.8
Jan. 24, 2015 (CN) 201510037180.5

(51) Int. Cl. G02C 1/02; G02C 5/16; G02C 5/14; G02C 5/06; G02C 5/12

(52) U.S. Cl. CPC G02C 1/02; G02C 5/06; G02C 5/12; G02C 5/146; G02C 5/16; G02C 2200/32

(57) ABSTRACT

A pair of rimless eyeglasses includes a pair of lenses, a bridge, a bridge fixing unit and an adhesive unit including two UV cured adhesive members. Each of the lenses is formed with an inner through hole. The bridge fixing unit includes a pair of bridge engaging members disposed on the bridge and each having a bridge engaging head, and a pair of bridge fixing members, each of which has a bridge fixing wall and a receiving space. The bridge engaging heads are respectively inserted into the inner through holes. The bridge fixing walls are respectively inserted into the inner through holes such that the bridge engaging heads are respectively and fixedly bonded to the receiving spaces through the UV cured adhesive members, which are disposed in the receiving spaces.

### CROSS-REFERENCE TO RELATED APPLICATIONS

This application is a continuation-in-part (CIP) of U.S. patent application Ser. No. 14/698250, filed on Apr. 28, 2015, and claims priorities of Chinese Patent Application No. 201420416076.8, filed on Jul. 25, 2014, Chinese Patent Application No. 201420221855.2, filed on Apr. 30, 2014, and Chinese Patent Application No. 201510037180.5, filed on Jan. 24, 2015.

### FIELD

The disclosure relates to a pair of eyeglasses, more particularly to a pair of rimless eyeglasses.

### BACKGROUND

Referring to FIG. 1, a pair of conventional rimless eyeglasses 1 includes a lens unit 11, a bridge unit 12, two nose pads 13 (only one is shown) and two temple units 14 (only one is shown). Since the conventional rimless eyeglasses 1 have symmetrical left and right parts, only the left part of the conventional rimless eyeglasses 1 is illustrated in FIG. 1 for the sake of brevity.

The lens unit 11 includes two spaced-apart lenses 111, each of which is formed with an inner through hole 112 proximate to the other one of the lenses 111, and an outer through hole 113 distal from the other one of the lenses 111.

The bridge unit 12 includes a strip-shaped bridge 121, two threaded holes 122 that are respectively formed in opposite ends of the bridge 121, and two screws 123. Each of the threaded holes 122 is aligned with the inner through hole 112 of a respective one of the lenses 111. Each of the screws 123 is threaded into a respective one of aligned pairs of the inner through holes 112 and the threaded holes 122. The lenses 111 are thereby connected to the bridge 121.

The nose pads 13 extend from the bridge 121 for abutting against a user's nasal bridge and supporting the bridge 121.

Each of the temple units 14 includes a connecting body 143 formed with a threaded hole 144, a hinge 142 disposed on the connecting body 143 opposite to the threaded hole 144, a temple body 141 pivotally connected to the hinge 142, and a screw 145. The threaded hole 144 of each of the temple units 14 is aligned with the outer through hole 113 of a respective one of the lenses 111. The screw 145 of each of the temple units 14 is threaded into a respective one of aligned pairs of the outer through holes 113 and the threaded holes 144. The temple units 14 are thereby connected to the lenses 111. The temple body 141 of each of the temple units 14 is pivotable about the hinge 142 and relative to a respective one of the lenses 111 for converting the conventional rimless eyeglasses 1 between a storable state and a wearable state.

However, since the lenses 111 are drilled with the inner through holes 112 and the outer through holes 113, then firmly fixed through engagement of the screws 123, 145 and the threaded holes 122, 144, assembly or disassembly of the conventional rimless eyeglasses 1 during manufacture or maintenance is a complicated and time-consuming process. Moreover, the lenses 111 may break due to stress concentration caused by tight engagement between the screws 123, 145 and the threaded holes 122, 144. Further, the screws 123, 145 may work loose from the threaded holes 122, 144 after long-term use of the conventional rimless eyeglasses 1, which may cause the lenses 111 to be detached from the bridge 121 and the temple units 14.

Therefore, is desirable to provide a pair of improved rimless eyeglasses.

### SUMMARY

Therefore, an aspect of the present disclosure is to provide a pair of rimless eyeglasses that is able to overcome at least one of the aforesaid drawbacks associated with the conventional rimless eyeglasses.

According to the disclosure, the rimless eyeglasses include a lens unit, a bridge unit, a bridge fixing unit and an adhesive unit. The lens unit includes a pair of spaced-apart lenses. Each of the lenses is formed with an inner through hole unit that has at least one noncircular inner through hole proximate to the other one of the lenses. The bridge unit includes a bridge. The bridge fixing unit includes a pair of bridge engaging members that are disposed on opposite ends of the bridge, and a pair of bridge fixing members. Each of the bridge engaging members has a bridge engaging base and a bridge engaging head that projects from the bridge engaging base. Each of the bridge fixing members has a bridge fixing base and a bridge fixing wall that projects from the bridge fixing base and that defines a receiving space. The adhesive unit includes two first UV cured adhesive members, each of which is disposed in the first receiving space of a respective one of the bridge fixing members. The bridge engaging head of each of the bridge engaging members is inserted into the inner through hole of a respective one of the inner through hole units of the lenses from one side of the lenses. The bridge fixing wall of each of the bridge fixing members is inserted into the inner through hole of a respective one of the inner through hole units of the lenses from an opposite side of the lenses such that the bridge engaging head of each of the bridge engaging members extends into the receiving space of a respective one of the bridge fixing members and is fixedly bonded to the bridge fixing wall of the respective one of the bridge fixing members through a respective one of the first UV cured adhesive members so as to fix the lenses to the bridge.

### BRIEF DESCRIPTION OF THE DRAWINGS

Other features and advantages of the present disclosure will become apparent in the following detailed description of the embodiments with reference to the accompanying drawings, of which:

FIG. 1 is a fragmentary partly cross-sectional view of a pair of conventional rimless eyeglasses;

FIG. 2 is a fragmentary partly exploded perspective view of a first embodiment of a pair of rimless eyeglasses of the present disclosure;

FIG. 3 is a fragmentary partly cross-sectional view of the first embodiment;

FIG. 4 is a schematic view showing an axis passing through inner through hole units of lenses of the first embodiment, and another axis passing through outer through hole units of the lenses of the first embodiment;

FIG. 5 is a schematic view showing an inner through hole of one of the inner through hole units of the first embodiment, in which the inner through hole has a pair of orthogonal major and minor axes;

FIG. 6 is a schematic view showing an outer through hole of one of the outer through hole units of the first embodiment, in which the outer through hole has a pair of orthogonal major and minor axes;

FIG. 7 is a fragmentary schematic view of the first embodiment showing a bridge engaging member being fixedly bonded to a bridge fixing member through a first UV cured adhesive member of an adhesive unit;

FIG. 8 is a fragmentary schematic view of the first embodiment showing a temple engaging member being fixedly bonded to a temple fixing member through a second UV cured adhesive member of the adhesive unit;

FIG. 9 is a fragmentary partly exploded perspective view of a second embodiment of the rimless eyeglasses of the present disclosure;

FIG. 10 is a fragmentary partly exploded cross-sectional view of the second embodiment;

FIG. 11 is a fragmentary partly exploded cross-sectional view of a third embodiment of the rimless eyeglasses of the present disclosure;

FIG. 12 is a fragmentary partly exploded cross-sectional view of a fourth embodiment of the rimless eyeglasses of the present disclosure;

FIG. 13 is a schematic view of this disclosure, showing a plurality of the inner through holes aligned along the axis, and a plurality of the outer through holes aligned along the another axis;

FIG. 14 is a schematic view of this disclosure, illustrating the inner and outer through holes of one of the lenses, each of the inner and outer through holes being in the shape of a racetrack;

FIG. 15 is a schematic view of this disclosure, illustrating the inner and outer through holes of one of the lenses, each of the inner and outer through holes being in the shape of an ellipse;

FIG. 16 is a schematic view of this disclosure, illustrating the inner and outer through holes of one of the lenses, each of the inner and outer through holes being in the shape of a rectangle; and

FIG. 17 is a schematic view of this disclosure, illustrating the inner and outer through holes of one of the lenses, each of the inner and outer through holes being in the shape of a polygon.

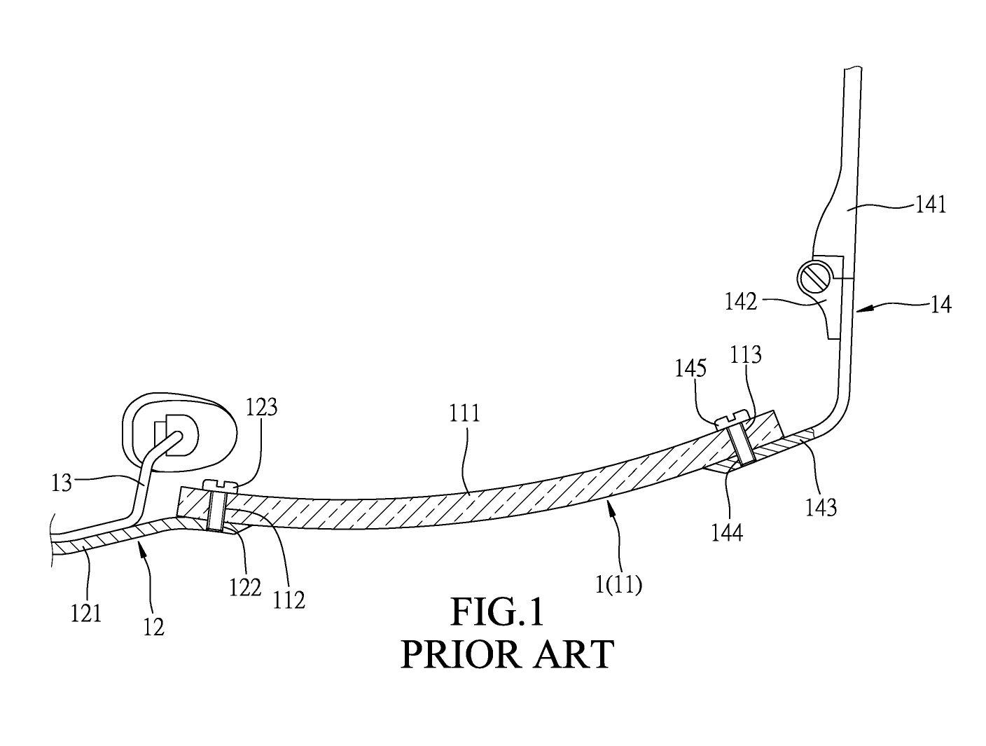

### DETAILED DESCRIPTION

Before the disclosure is described in greater detail with reference to the accompanying embodiments, it should be noted herein that like elements are denoted by the same reference numerals throughout the disclosure.

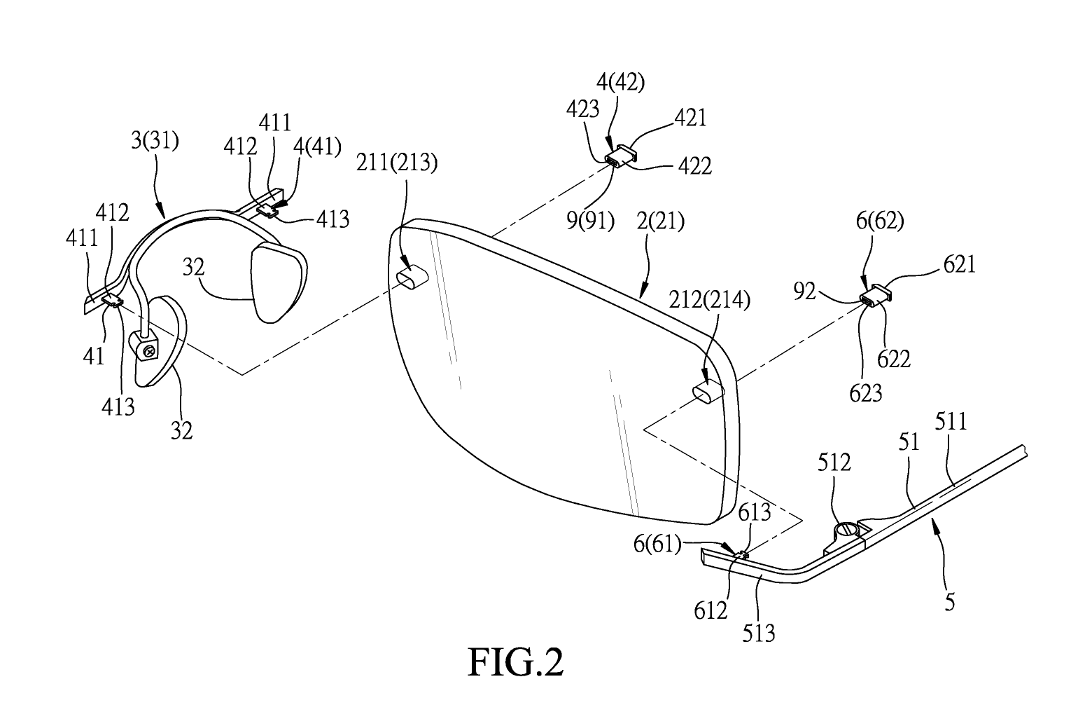

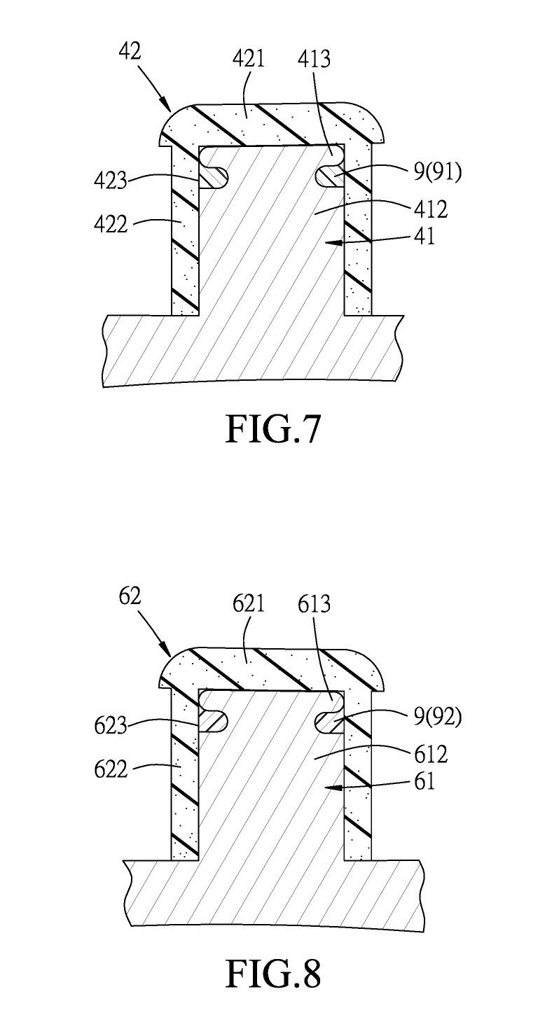

Referring to FIGS. 2, 3, 7 and 8, a first embodiment of a pair of rimless eyeglasses according to the present disclosure includes a lens unit 2, a bridge unit 3, a bridge fixing unit 4, a temple unit 5, a temple fixing unit 6 and an adhesive unit 9. Since the rimless eyeglasses have symmetrical left and right parts, only the left part of the rimless eyeglasses is illustrated in certain figures of this disclosure for the sake of brevity.

The lens unit 2 includes two spaced-apart lenses 21, each of which is formed with an inner through hole unit 211 and an outer through hole unit 212. In this embodiment, the inner through hole unit 211 of each of the lenses 21 has a noncircular inner through hole 213 proximate to the other one of the lenses 21.

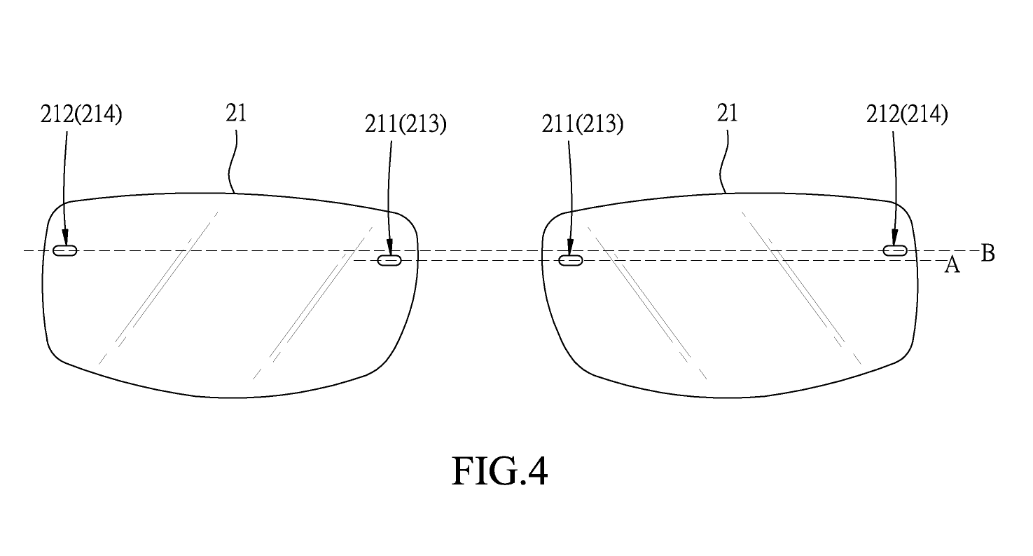

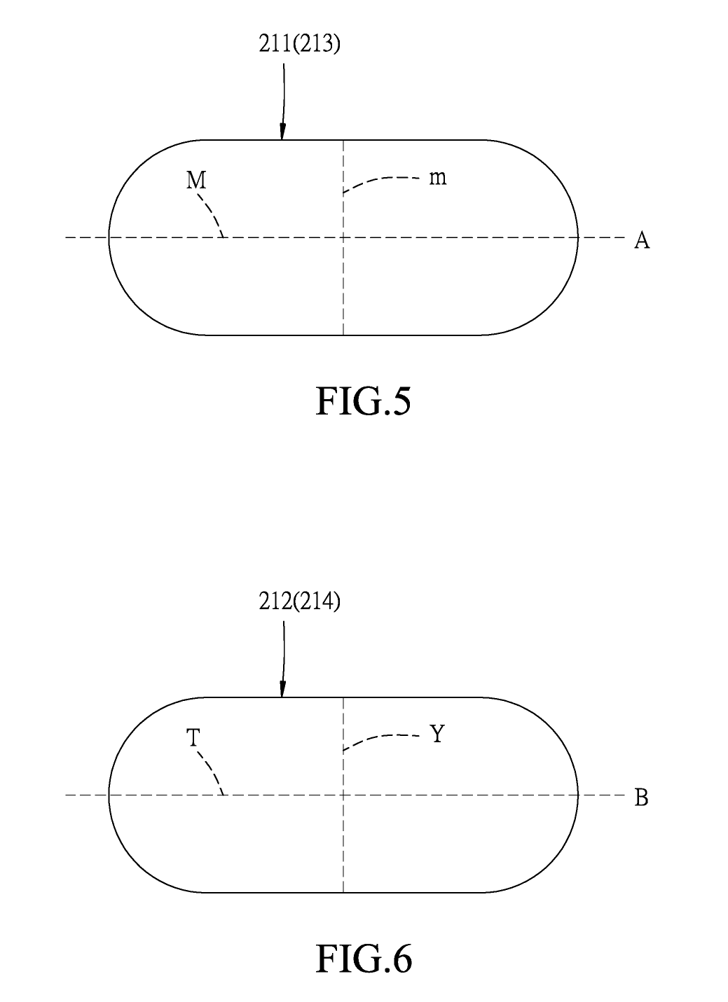

Referring further to FIGS. 4 to 6, the inner through hole 213 of each of the inner through hole units 211 has a pair of orthogonal major and minor axes (M, m), in which the major axis (14) is substantially parallel to an axis (A) that passes through the inner through hole units 211 of the lenses 21 and has a length larger than that of the minor axis (m). The outer through hole unit 212 has a noncircular outer through hole 214 distal from the other one of the lenses 21. The outer through hole 214 has a pair of orthogonal major and minor axes (T, Y), in which the major axis (T) is substantially parallel to an axis (B) that passes through the outer through hole units 212 of the lenses 21 and has a length larger than that of the minor axis (Y). The axes (A, B) are spaced apart from each other in this embodiment. However, in certain embodiments, the axes (A, B) are exemplified to be overlapped. In other words, the relative location of the inner through hole units 211 and the outer through hole units 212 can be changed based on actual requirements. The bridge unit 3 includes a bridge 31 to which the lenses 21 are connected, and two nose pads 32 which extend from the bridge 31 for abutting against a user's nasal bridge and supporting the bridge 31.

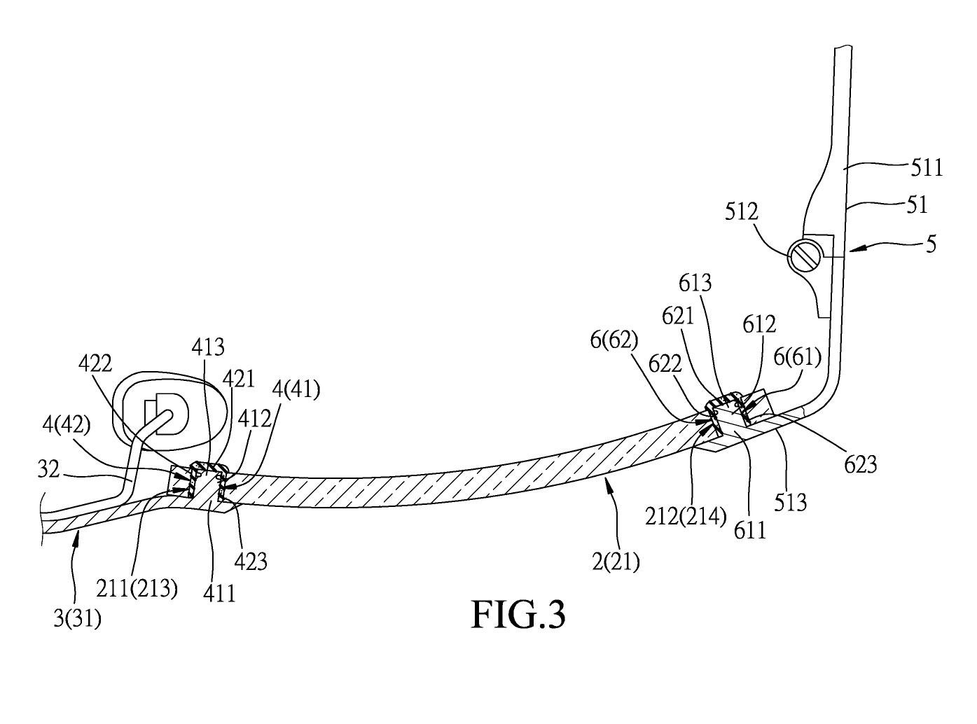

The bridge fixing unit 4 includes two bridge engaging members 41 that are disposed on opposite ends of the bridge 31, and two bridge fixing members 42. Each of the bridge engaging members 41 has a bridge engaging base 411, a bridge engaging arm 412 that extends from the bridge engaging base 411, and a bridge engaging head 413 that projects from a distal end of the bridge engaging arm 412. Referring to FIG. 3, in this embodiment, the bridge engaging head 413 of each of the bridge engaging members 41 has a cross-section having the shape of a double-bitted axe blade. Each of the bridge fixing members 42 has a bridge fixing base 421 and a bridge fixing wall 422 that projects from the bridge fixing base 421 and that defines a first receiving space 423.

It should be noted that, in the first embodiment of the present disclosure, the bridge engaging heads 413 of the bridge engaging members 41 are resiliently deformable. However, the bridge fixing walls 422 of the bridge fixing members 42 may also be configured to be resiliently deformable. In an alternative embodiment, only the bridge fixing walls 422 of the bridge fixing members 42 are resiliently deformable.

The adhesive unit 9 includes two first UV cured adhesive members 91, each of which is disposed in the first receiving space 423 of a respective one of the bridge fixing members 42.

In this embodiment, the adhesive unit 9 is made of an ultraviolet curable adhesive purchased from the Loctite Corporation. It should be noted that other brands of UV cured adhesive may be used, based on the materials of the bridge fixing unit 4 and the temple fixing unit 6 as long as secure bonding can be achieved.

The bridge engaging arm 412 and the bridge engaging head 413 of each of the bridge engaging members 41 are inserted into the inner through hole 213 of a respective one of the inner through hole units 211 of the lenses 21 from one side of the lenses 21. The bridge fixing wall 422 of each of the bridge fixing members 42 is inserted into the inner through hole 213 of a respective one of the inner through hole units 211 of the lenses 21 from an opposite side of the lenses 21 such that the bridge engaging head 413 and the bridge engaging arm 412 of each of the bridge engaging members 41 extend into the first receiving space 423 of the bridge fixing wall 422 of a respective one of the bridge fixing members 42 and are fixedly bonded to the bridge fixing wall 422 of the respective one of the bridge fixing members 42 through a respective one of the first UV cured adhesive members 91 disposed in the first receiving space 423 so as to fix the lenses 21 to the bridge 31. The bridge engaging base 411 of each of the bridge engaging members 41 abuts against the one side of a respective one of the lenses 21. The bridge fixing base 421 of each of the bridge fixing members 42 abuts against the opposite side of a respective one of the lenses 21.

Each of the first UV cured adhesive members 91 is exemplified to fill only a portion of the first receiving space 423 of the respective one of the bridge fixing members 42 to avoid adhesive spill after respectively inserting the bridge engaging head 413 and the bridge engaging arm 412 of the bridge engaging members 41 into the first receiving spaces 423 of the bridge fixing members 42. The amount of the first UV cured adhesive members 91 may be adjusted based on the size of the bridge engaging members 41.

The temple unit 5 includes two temples 51, each of which includes a connecting body 513, a hinge 512 that is disposed on an end of the connecting body 513, and a temple body 511 that is connected pivotally to the hinge 512.

The temple fixing unit 6 includes two temple engaging members 61 and two temple fixing members 62. Each of the temple engaging members 61 is disposed on the connecting body 513 of a respective one of the temples 51 at a position opposite to the hinge 512 of the respective one of the temples 51. Each of the temple fixing members 62 has a temple fixing base 621, a temple fixing wall 622 that projects from the temple fixing base 621, and a second receiving space 623 that is defined by the temple fixing wall 622. Each of the temple engaging members 61 has a temple engaging base 611, a temple engaging arm 612 that extends from the temple engaging base 611, and a temple engaging head 613 that projects from the temple engaging arm 612. Referring to FIG. 3, in this embodiment, the temple engaging head 613 of each of the temple engaging members 61 has a cross-section having the shape of a double-bitted axe blade.

It should be noted that, in the first embodiment of the present disclosure, the temple engaging heads 613 of the temple engaging members 61 are resiliently deformable. However, the temple fixing walls 622 of the temple fixing members 62 may also be configured to be resiliently deformable. In an alternative embodiment, only the temple fixing walls 622 of the temple fixing members 62 are resiliently deformable.

The adhesive unit 9 further includes two second UV cured adhesive members 92, each of which is disposed in the second receiving space 623 of a respective one of the temple fixing members 62.

The temple engaging arm 612 and the temple engaging head 613 of each of the temple engaging members 61 are inserted into the outer through hole 214 of a respective one of the outer through hole units 212 of the lenses 21 from the one side of the lenses 21. The temple fixing wall 622 of each of the temple fixing members 62 is inserted into the outer through hole 214 of a respective one of the outer through hole units 212 of the lenses 21 from the opposite side of the lenses 21 such that the temple engaging head 613 and the temple engaging arm 612 of each of the temple engaging members 61 extend into the second receiving space 623 of a respective one of the temple fixing members 62 and are fixedly bonded to the temple fixing wall 622 of a respective one of the temple fixing members 62 through a respective one of the second UV cured adhesive members 92 disposed in the second receiving space 623 so as to respectively fix the temples 51 to the lenses 21. The temple engaging base 611 of each of the temple engaging members 61 abuts against the one side of a respective one of the lenses 21. The temple fixing base 621 of each of the temple fixing members 62 abuts against the opposite side of a respective one of the lenses 21.

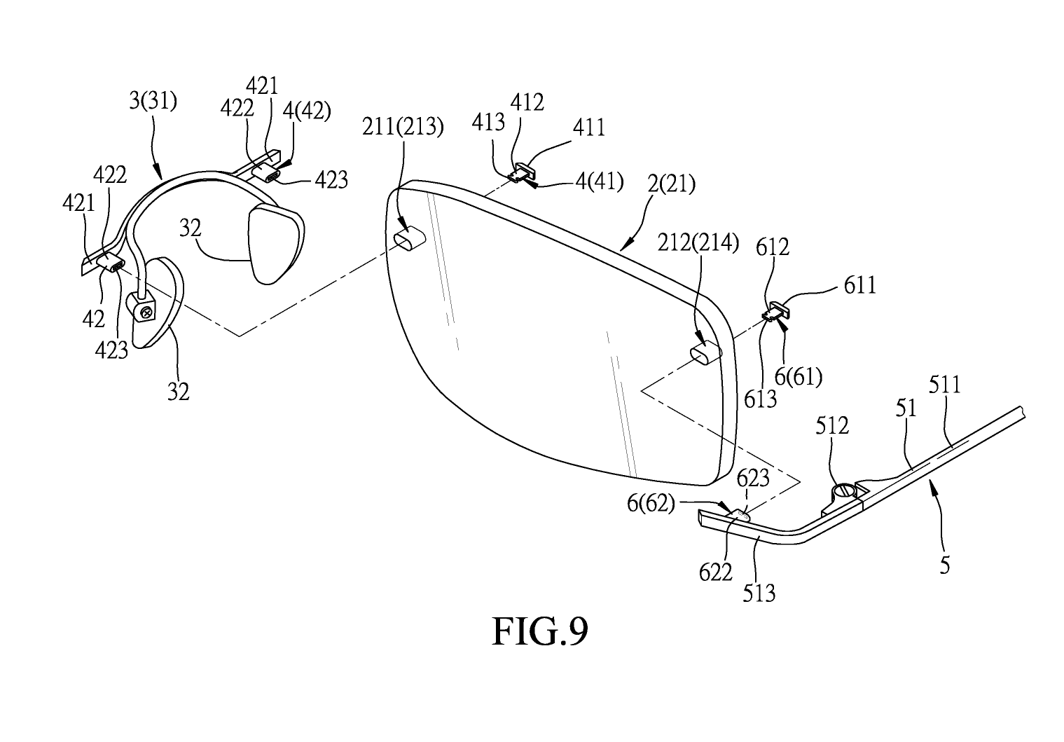

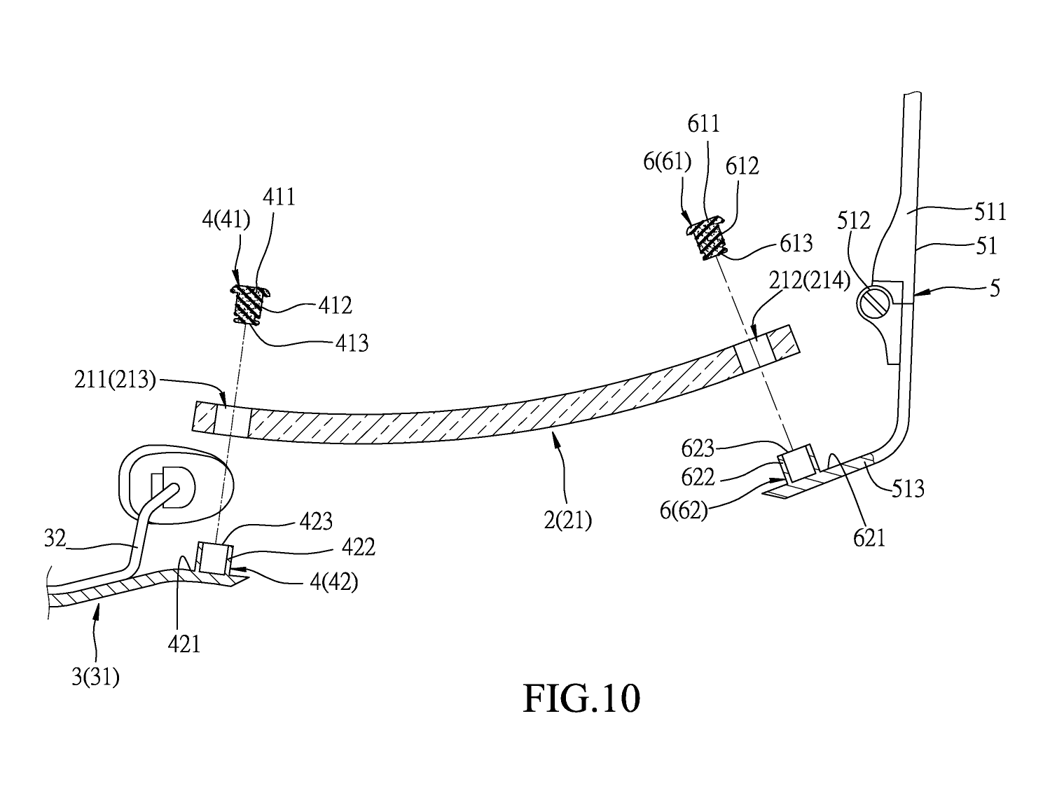

Referring to FIGS. 9 and 10, a second embodiment of the rimless eyeglasses according to the present disclosure has a structure similar to that of the first embodiment. The differences reside in that the locations of the bridge fixing members 42 and the bridge engaging members 41 are interchanged, and that the locations of the temple fixing members 62 and the temple engaging members 61 are interchanged.

To be more specific, the bridge fixing wall 423 of each of the bridge fixing members 42 is inserted into the inner through hole 213 of a respective one of the inner through hole units 211 of the lenses 21 from the one side of the lenses 21. The bridge engaging arm 412 and the bridge engaging head 413 of each of the bridge engaging members 41 are inserted into the inner through hole 213 of a respective one of the inner through hole units 211 of the lenses 21 from the opposite side of the lenses 21. The temple fixing wall 622 of each of the temple fixing members 62 is inserted into the outer through hole 214 of a respective one of the outer through hole units 212 of the lenses 21 from the one side of the lenses 21. The temple engaging arm 612 and the temple engaging head 613 of each of the temple engaging members 61 are inserted into the outer through hole 214 of a respective one of the outer through hole units 212 of the lenses 21 from the opposite side of the lenses 21.

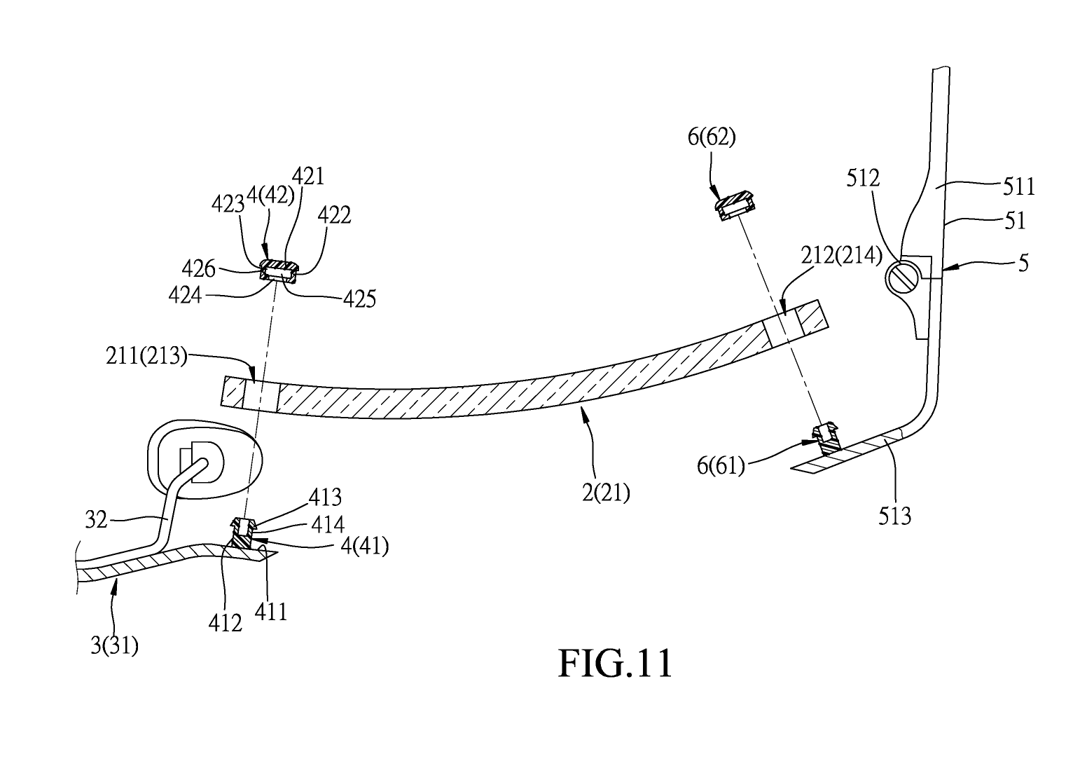

Referring to FIG. 11, a third embodiment of the rimless eyeglasses according to the present disclosure has a structure similar to that of the first embodiment. The differences reside in the structures of the bridge fixing unit 4 and the temple fixing unit 6.

The bridge fixing unit 4 includes two bridge engaging members 41 that are disposed on opposite ends of the bridge 31, and two bridge fixing members 42. Each of the bridge engaging members 41 has a bridge engaging base 411, a bridge engaging arm 412 that has a plurality of bridge engaging arm portions 414 extending from the bridge engaging base 411, and a plurality of bridge engaging heads 413 projecting respectively from the bridge engaging arm portions 414. Each of the bridge fixing members 42 has a bridge fixing base 421 and a bridge fixing wall 422 that projects from the bridge fixing base 421, and a first receiving space 423, which is defined by the bridge fixing wall 422 and which has a small hole part 424 and a large hole part 425 that cooperatively define an abutting portion 426.

It should be noted that, in the third embodiment of the present disclosure, the bridge engaging heads 413 of the bridge engaging members 41 are resiliently deformable. However, the bridge fixing walls 422 of the bridge fixing members 42 may also be configured to be resiliently deformable. In an alternative embodiment, only the bridge fixing walls 422 of the bridge fixing members 42 are resiliently deformable.

The bridge engaging arm 412 and the bridge engaging heads 413 of each of the bridge engaging members 41 are inserted into the inner through hole 213 of a respective one of the inner through hole units 211 of the lenses 21 from the one side of the lenses 21. The bridge fixing wall 422 of each of the bridge fixing members 42 is inserted into the inner through hole 213 of a respective one of the inner through hole units 211 of the lenses 21 from the opposite side of the lenses 21 such that the bridge engaging arm 412 of each of the bridge engaging members 41 is received in the first receiving space 423 of a respective one of the bridge fixing members 42 and that the bridge engaging head 413 of each of the bridge engaging members 41 is received in the large hole part 425 of the first receiving space 423 of the respective one of the bridge fixing members 42, abuts against the abutting portion 426 of the respective one of the bridge fixing members 42, and is fixedly bonded to the bridge fixing wall 422 of the respective one of the bridge fixing members 42 through the manner as disclosed in the first embodiment, so as to fix the lenses 21 to the bridge 31. The bridge engaging base 411 of each of the bridge engaging members 41 abuts against the one side of a respective one of the lenses 21. The bridge fixing base 421 of each of the bridge fixing members 42 abuts against the opposite side of a respective one of the lenses 21.

The temple fixing unit 6 includes two temple engaging members 61 and two temple fixing members 62. Each of the temple engaging members 61 has a structure the same as that of a respective one of the bridge engaging members 41 and each of the temple fixing members 62 has a structure the same as that of a respective one of the bridge fixing members 42, further elaboration regarding the structures of the temple engaging members 61 and the temple fixing members 62 will not be presented here for the sake of brevity.

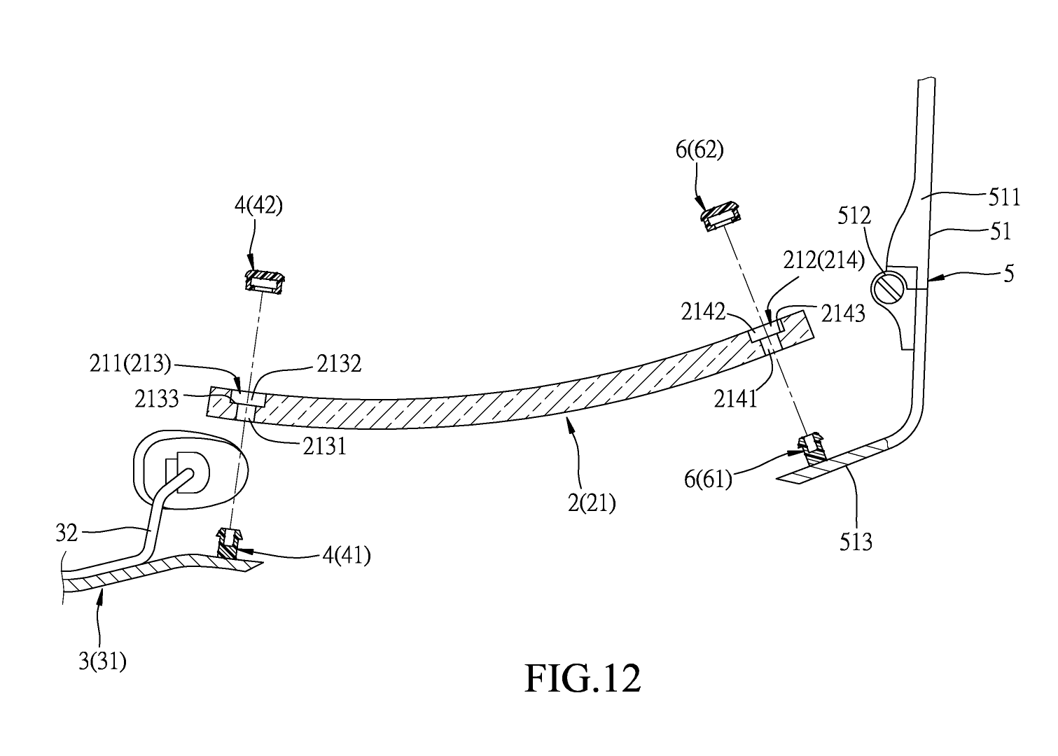

Referring to FIG. 12, a fourth embodiment of the rimless eyeglasses according to the present disclosure has a structure similar to that of the third embodiment. The differences reside in the structures of the inner through hole 213 of the inner through hole unit 211 and the outer through hole 214 of the cuter through hole unit 212 of each of the lenses 21.

In the fourth embodiment, the inner through hole 213 of the inner through hole unit 211 of each of the lenses 21 has small and large hole parts 2131, 2132 that are in spatial communication with each other and that cooperatively define an inner abutting portion 2133 therebetween. Each of the bridge engaging members 41 of the bridge fixing unit 4 extends through the small hole part 2131 of the inner through hole 213 of the inner through hole unit 211 of a respective one of the lenses 21. Each of the bridge fixing members 42 of the bridge fixing unit 4 is completely received in the large hole part 2132 of the inner through hole 213 of the inner through hole unit 211 of a respective one of the lenses 21, abuts against the inner abutting portion 2133, and is fixedly bonded to a respective one of the bridge engaging members 41 of the bridge fixing unit 4 through the manner as disclosed in the first embodiment.

It should be noted that, with the bridge fixing members 42 of the bridge fixing unit 4 being respectively received in the large hole parts 2132 of the inner through holes 213, the rimless eyeglasses may have a sleek look and improved aesthetic appearance.

The outer through hole 214 of the outer through hole unit 212 of each of the lenses 21 has small and large hole parts 2141, 2142 that are in spatial communication with each other and that cooperatively define an outer abutting portion 2143 therebetween. Each of the temple engaging members 61 of the temple fixing unit 6 extends through the small hole part 2141 of the outer through hole 214 of the outer through hole unit 212 of a respective one of the lenses 21. Each of the temple fixing members 62 of the temple fixing unit 6 is completely received in the large hole part 2142 of the outer through hole 214 of the outer through hole unit 212 of a respective one of the lenses 21, abuts against the outer abutting portion 2143, and is fixedly bonded to a respective one of the temple engaging members 61 of the temple fixing unit 6 through the manner as disclosed in the first embodiment.

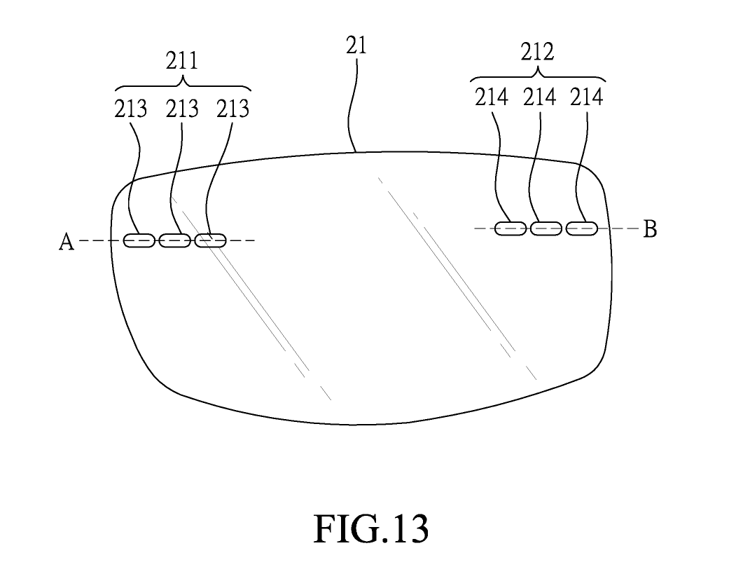

Referring to FIG. 13, in certain embodiments, each of the inner through hole units 211 may have a plurality of the inner through holes 213 that are aligned along the axis (A) passing through the inner through hole units 211 of the lenses (21), and each of the outer through hole units 212 may have a plurality of the outer through holes 214 that are aligned along the axis (B) passing through the outer through hole units 212 of the lenses 21. The bridge fixing unit 4 may have a plurality of the bridge engaging members 41 and a plurality of the bridge fixing members 42, which correspond in number to that of the inner through holes 213. The temple fixing unit 6 may have a plurality of the temple engaging members 61 and a plurality of the temple fixing members 62, which correspond in number to that of the outer through holes 214. Therefore, the lenses 21 of the lens unit 2 maybe firmly fixed to the bridge 31 of the bridge unit 3, and the temples 51 of the temple unit 5 may be respectively and firmly fixed to the lenses 21.

It should be added that the number of the temples 51 of the temple unit 5 is not limited to two, and may be altered or even omitted, as long as the lenses 21 of the lens unit 2 is able to be respectively positioned in front of the user's eyes for viewing.

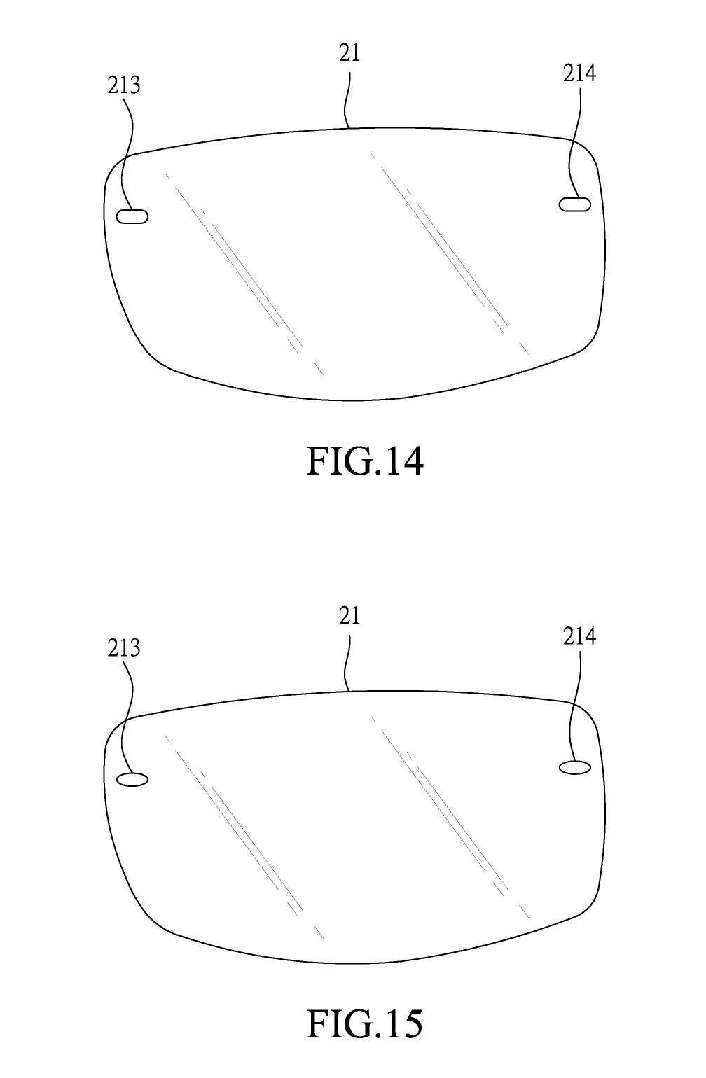

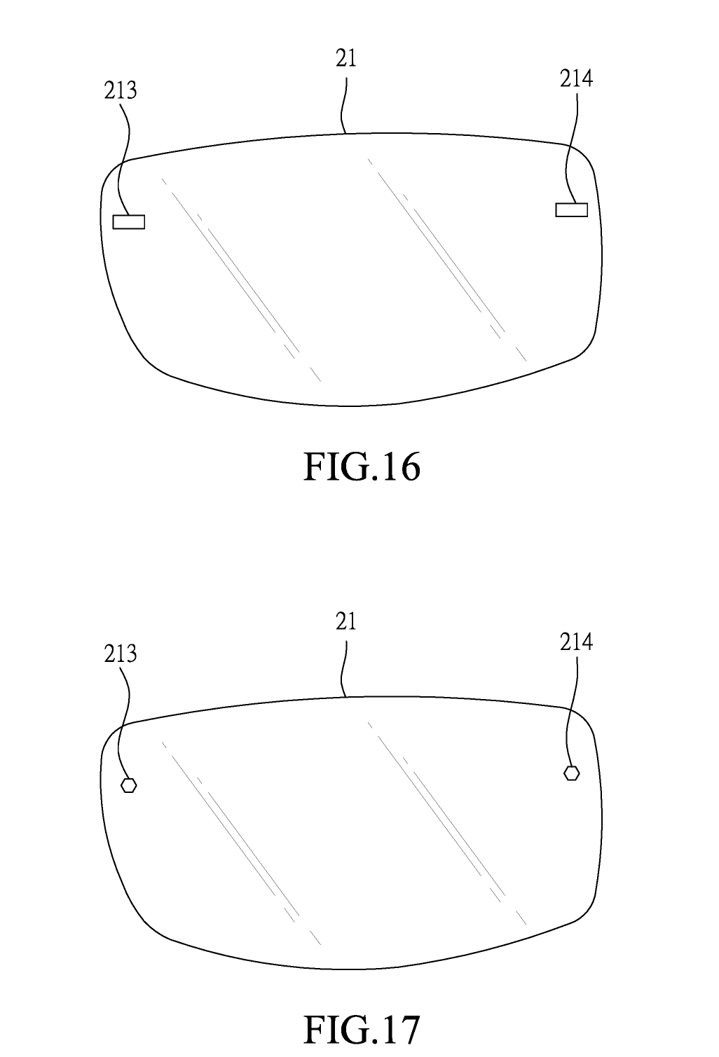

Referring to FIGS. 14 to 17, the inner through hole 213 and the outer through hole 214 may each have the shape of a racetrack (see FIG. 14), an ellipse (see FIG. 15), a rectangle (see FIG. 16) or a polygon (see FIG. 17) for an improved aesthetic appearance. Alternatively, each of the inner through hole 213 and the outer through hole 214 may be configured to be non-symmetrical in shape, misconnections between the bridge unit 3 and the lens unit 2 or between the temple unit 5 and the lens unit 2 can be prevented.

To sum up, the present disclosure facilitates assembly of the rimless eyeglasses by virtue of the configuration of the bridge fixing unit 4, the temple fixing unit 6 and the adhesive unit 9. Each of the bridge engaging members 41 of the bridge engaging unit 4 can be fixedly bonded to the respective one of the bridge fixing members 42 through the respective one of the first UV cured adhesive members 91. Likewise, each of the temple engaging members 61 of the temple fixing unit 6 can be fixedly bonded to the respective one of the temple fixing members 62 through the respective one of the second UV cured adhesive members 92. The integrity of the rimless eyeglasses may thereby be unaffected even after long-term use.

In the description above, for the purposes of explanation, numerous specific details have been set forth in order to provide a thorough understanding of the embodiments. It will be apparent, however, to one skilled in the art, that one or more other embodiments may be practiced without some of these specific details.

It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A pair of rimless eyeglasses comprising:
a lens unit including a pair of spaced-apart lenses, each of which is formed with an inner through hole unit that has at least one noncircular inner through hole proximate to the other one of said lenses; a bridge unit including a bridge;
a bridge fixing unit including
a pair of bridge engaging members that are disposed on opposite ends of said bridge, each of said bridge engaging members having a bridge engaging base and a bridge engaging head that projects from said bridge engaging base, and
a pair of bridge fixing members, each of said bridge fixing members having a bridge fixing base and a bridge fixing wall that projects from said bridge fixing base and that defines a first receiving space; and
an adhesive unit including two first UV cured adhesive members, each of which is disposed in said first receiving space of a respective one of said bridge fixing members,
wherein said bridge engaging head of each of said bridge engaging members is inserted into said inner through hole of a respective one of said inner through hole units of said lenses from one side of said lenses, said bridge fixing wall of each of said bridge fixing members being inserted into said inner through hole of a respective one of said inner through hole units of said lenses from an opposite side of said lenses such that said bridge engaging head of each of said bridge engaging members extends into said first receiving space of a respective one of said bridge fixing members and is fixedly bonded to said bridge fixing wall of the respective one of said bridge fixing members through a respective one of said first UV cured adhesive members so as to fix said lenses to said bridge.

2. The pair of rimless eyeglasses as claimed in claim 1, wherein said bridge engaging heads of said bridge engaging members and/or said bridge fixing walls of said bridge fixing members are resiliently deformable.

3. The pair of rimless eyeglasses as claimed in claim 1, wherein said at least one inner through hole of each of said inner through hole units has a pair of orthogonal major and minor axes, the major axis being substantially parallel to an axis that passes through said inner through hole units of said lenses and having a length larger than that of the minor axis.

4. The pair of rimless eyeglasses as claimed in claim 1, wherein said at least one inner through hole of each of said inner through hole units has the shape of a racetrack, an ellipse or a polygon.

5. The pair of rimless eyeglasses as claimed in claim 1, wherein:
said at least one inner through hole of each of said inner through hole units has small and large hole parts that are in spatial communication with each other and that cooperatively define an inner abutting portion therebetween;
each of said bridge engaging members of said bridge fixing unit extends through said small hole part of said inner through hole of said inner through hole unit of a respective one of said lenses; and
each of said bridge fixing members of said bridge fixing unit is received in said large hole part of said inner through hole of said inner through hole unit of a respective one of said lenses, abuts against said inner abutting portion, and is fixedly bonded to a respective one of said bridge engaging members of said bridge fixing unit through a respective one of the first UV cured adhesive members.

6. The pair of rimless eyeglasses as claimed in claim 1, wherein each of said inner through hole units has a plurality of said inner through holes that are aligned along an axis passing through said inner through hole units of said lenses.

7. The pair of rimless eyeglasses as claimed in claim 5, wherein each of said inner through holes has the shape of a racetrack, an ellipse or a polygon.

8. The pair of rimless eyeglasses as claimed in claim 1, wherein said bridge unit further includes a pair of nose pads extending from said bridge.

9. The pair of rimless eyeglasses as claimed in claim 1, wherein:
each of said lenses is further formed with an outer through hole unit that has at least one noncircular outer through hole distal from the other one of said lenses;
said pair of rimless eyeglasses further comprises
a temple unit that includes a pair of temples, and
a temple fixing unit that includes a pair of temple engaging members respectively disposed on said temples, and a pair of temple fixing members each having a second receiving space;
said adhesive unit further includes two second UV cured adhesive members, each of which is disposed in said second receiving space of a respective one of said temple fixing members; and
said temple engaging members is respectively inserted into said outer through hole units from said one side of said lenses, said temple fixing members being respectively inserted into said outer through hole units from said opposite side of said lenses such that said temple engaging members respectively extend into said second receiving spaces of said temple fixing members and are respectively and fixedly bonded to said temple fixing members through said second UV cured adhesive members so as to respectively fix said temples to said lenses.

10. The pair of rimless eyeglasses as claimed in claim 9, wherein each of said temple fixing members has a temple fixing base and a temple fixing wall that projects from said temple fixing base and that defines said second receiving space of said temple fixing member, each of said temple engaging members having a temple engaging base and a temple engaging head that projects from said temple engaging base, said temple engaging head of each of said temple engaging members being fixedly bonded to said temple fixing wall of the respective one of said temple fixing members through the respective one of said second UV cured adhesive members.

11. The pair of rimless eyeglasses as claimed in claim 10, wherein said temple engaging heads of said temple engaging members and/or said temple fixing walls of said temple fixing members are resiliently deformable.

12. The pair of rimless eyeglasses as claimed in claim 9, wherein each of said temples includes a connecting body on which a respective one of said temple engaging members is disposed, a hinge disposed on said connecting body opposite to said respective one of said temple engaging members, and a temple body connected pivotally to said hinge.

13. The pair of rimless eyeglasses as claimed in claim 9, wherein said at least one outer through hole of each of said outer through hole units has the shape of a racetrack, an ellipse or a polygon.

14. The pair of rimless eyeglasses as claimed in claim 9, wherein said at least one outer through hole of each of said outer through hole units has a pair of orthogonal major and minor axes, the major axis being substantially parallel to an axis that passes through said outer through hole units of said lenses and having a length larger than that of the minor axis.

15. The pair of rimless eyeglasses as claimed in claim 9, wherein:
said at least one outer through hole of each of said outer through hole units has small and large hole parts that are in spatial communication with each other and that cooperatively define an outer abutting portion therebetween;
each of said temple engaging members of said temple fixing unit extends through said small hole part of said outer through hole of said outer through hole unit of a respective one of said lenses; and
each of said temple fixing members of said temple fixing unit is received in said large hole part of said outer through hole of said outer through hole unit of a respective one of said lenses, abuts against said outer abutting portion, and is fixedly bonded to the respective one of said temple engaging members of said temple fixing unit through the respective one of the second UV cured adhesive members.

16. The pair of rimless eyeglasses as claimed in claim 9, wherein each of said outer through hole units has a plurality of outer through holes that are aligned along an axis passing through said outer through hole units of said lenses.

17. The pair of rimless eyeglasses as claimed in claim 16, wherein each of said outer through holes has the shape of a racetrack, an ellipse or a polygon.
